(19) United States
(12) Patent Application Publication
(10) Pub. No.: US 2024/0123877 A1
(43) Pub. Date: Apr. 18, 2024

(54) BOOSTER SEAT CONFIGURED FOR COMPACT SIDE-BY-SIDE POSITIONING

(71) Applicant: DIONO, LLC, Sumner, WA (US)

(72) Inventors: Michael H. Gillett, Silver Creek, WA (US); Sharon A. Gillett, Silver Creek, WA (US)

(21) Appl. No.: 18/488,624

(22) Filed: Oct. 17, 2023

Related U.S. Application Data
(60) Provisional application No. 63/417,172, filed on Oct. 18, 2022.

(51) Int. Cl. B60N 2/28; B60N 3/10

(52) U.S. Cl. CPC B60N 2/2821; B60N 2/2872; B60N 3/10

(57) ABSTRACT

A booster seat for supporting a child in a vehicle includes a lower base having a pair of sidewalls extending on opposing sides of a central axis, and a pair of narrowing walls also extending on opposing sides of the central axis. Each of the narrowing walls include at least one segment positioned between a pair of planes defined by the pair of sidewalls. A seatback frame is connectable to the lower base and includes a plurality of slots formed therein. A plurality of padding modules are detachably engageable with the seatback frame, with each padding module including a pad, a connecting fin coupled to the pad, and a locking flange coupled to the connecting pin. Each of the plurality of padding modules are insertable into a respective one of the plurality of slots to facilitate engagement between the plurality of padding modules and the seatback frame.

### CROSS-REFERENCE TO RELATED APPLICATIONS

This application claims the benefit of U.S. Provisional Application No. 63/417,172, filed Oct. 18, 2022, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to child booster seats, and more specifically, to a booster seat configured to be positionable adjacent a similar booster seat in a compact arrangement, particularly to enable three similar booster seats to be positioned adjacent each other in single row of a vehicle.

### 2. Description of the Related Art

Child safety seats are commonly used in vehicles to safely restrain a child within the vehicle and to provide protection to the child in the event of a vehicle collision. Infants may be placed in a rear-facing car seat that may be secured to the vehicle using the existing vehicle seatbelt, or via an anchoring system, such as a LATCH (Lower Anchors and Tethers for Children) system. The rear-facing car seat includes an integrated seat-belt system that is sized for the small bodies of infants.

As children grow older and become bigger and stronger, the child may graduate to a booster seat, which is designed to be used in a manner where the vehicle seat belt may extend over the child to restrain the child. In this regard, the booster seat may not include its own dedicated seat belt system. The booster seat may be configured to lift the child to allow the seat belt to extend over the proper areas of the child's body (e.g., over the collar bone and chest, as well as being fitted to the child's hips).

Children may use booster seats for several years, and thus, for families with multiple kids, there may be two or more children using booster seats at any given time. Furthermore, it is common for families to carpool to practices or other extracurricular events, and thus, additional children using booster seats may be present in a single vehicle. This may result in three children sitting in a single row of a vehicle requiring a booster seat.

Conventional booster seats are not sized to easily accommodate such an arrangement (e.g., side-by-side-by-side). In particular, due to the bulky sizing and configuration of conventional booster seats, it may be difficult access the seatbelt buckles, typically located at the rear—lower region of the vehicle seat. Furthermore, certain features which typically protrude outside the conventional footprint of a booster seat, such as a cupholder, may either need to be removed (if removable), or such feature may make it extremely difficult, if not impossible, to fit three booster seats in a single row.

Accordingly, there is a need in the art for an improved booster seat specifically sized and adapted to facilitate use in a group of three booster seats positioned in a single row of a vehicle. Various aspects of the present disclosure address this particular need, as will be discussed in more detail below.

### BRIEF SUMMARY

In accordance with one embodiment of the present disclosure, there is provided a booster seat for supporting a child in a vehicle. The booster seat includes a lower base having a pair of sidewalls extending on opposing sides of a central axis, and a pair of narrowing walls also extending on opposing sides of the central axis. Each of the pair of narrowing walls include at least one segment that is positioned between a pair of planes defined by the pair of sidewalls. The booster seat additionally includes a seatback frame connectable to the lower base and having a plurality of slots formed therein. A plurality of padding modules are detachably engageable with the seatback frame, with each padding module including a pad, a connecting fin coupled to the pad, and a locking flange coupled to the connecting pin. Each of the plurality of padding modules are insertable into a respective one of the plurality of slots to facilitate engagement between the plurality of padding modules and the seatback frame. Each locking flange engages the seatback frame when the corresponding padding module is inserted in the slot.

The booster seat may be configured to be positionable in a group of three booster seats which are sized to fit in a single row on a vehicle.

The seatback may be configured to be detachably connectable to the lower base.

The pair of sidewalls may define a maximum width therebetween and the pair of narrowing walls may define a minimum width therebetween, with the minimum width being less than the maximum width.

The booster seat may include at least one recess formed in the lower base and extending into the lower base from a respective one of the pair of sidewalls. The booster seat may include a cupholder insert configured to be removably received within a respective one of the at least one recess. The cupholder insert may include a lower portion defining a cup-holding recess and an upper portion defining an upper plate extending radially outward from the cup-holding recess. The upper plate may be selectively rotatable relative to the lower portion.

The at least one recess may define an arc length less than or equal to 180 degrees. The at least one recess may include a pair of recesses positioned in opposed relation to each other.

The lower base may further include a pair of armrests in opposed relation to each other. Each armrest may include a base portion and a removable arm portion, with the base portion being coupled to a respective one of the pair of sidewalls and the removable arm portion being configured to be detachably engaged with the base portion.

The lower base may include an upper pad extending between the pair of sidewalls, and a pair of hip pads extending from opposed side portions of the upper pad.

According to another embodiment, there is provided a booster seat for supporting a child in a vehicle. The booster seat includes a lower base having a pair of sidewalls extending on opposing sides of a central axis, and a pair of narrowing walls also extending on opposing sides of the central axis, each of the pair of narrowing walls including at least one segment that is positioned between a pair of planes defined by the pair of sidewalls. A seatback frame is connectable to the lower base. The booster seat also includes a plurality of padding modules operatively coupled to the seatback frame. Each padding module includes a pad and a respective cover, with at least one of the pad or the cover configured to be removable from the seatback frame.

Each pad may be detachably engageable with the seatback frame and each cover may be fixedly connected to a respective pad.

Each pad may be fixedly coupled to the seatback frame and each cover may be removable from the corresponding pad.

According to another embodiment, there is provided a primary booster seat for supporting a child in a vehicle, with the primary booster seat being configured for use with a cupholder insert and an adjacent booster seat having a lateral recess formed therein. The primary booster seat includes a lower base having a pair of sidewalls extending on opposing sides of a central axis. A pair of narrowing walls also extend on opposing sides of the central axis, with each of the pair of narrowing walls including at least one segment that is positioned between a pair of planes defined by the pair of sidewalls. A primary recess extends from one of the pair of sidewalls, with the primary recess being configured such that when the primary booster seat is positioned adjacent the adjacent booster seat, the primary recess and the lateral recess cooperatively define a cupholder recess sized to receive the cupholder insert. The booster seat additionally includes a seatback frame connectable to the lower base and having a plurality of slots formed therein. A plurality of padding modules are detachably engageable with the seatback frame, with each padding module including a pad, a connecting feature coupled to the pad, and a locking flange coupled to the connecting feature. Each of the plurality of padding modules is insertable into a respective one of the plurality of slots to facilitate engagement between the plurality of padding modules and the seatback frame. Each locking flange engages the seatback frame when the corresponding padding module is inserted in the slot.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of three booster seats specifically configured to allow for installation of the booster seats in a side-by-side-by-side configuration (e.g., 3-across);

FIG. 2 is a front view of the three booster seats of FIG. 1;

FIG. 3 is an upper perspective view of the three booster seats of FIG. 1, with a middle booster seat having a seatback detached from a lower base;

FIG. 4 is a partial top view of the two of the booster seats of FIG. 3 positioned adjacent the vehicle buckle, with the booster seats being configured to extend around the vehicle buckle to provide a large open area around the vehicle buckle;

FIG. 5 is an upper perspective view of two booster seats in a side-by-side configuration, to provide a depiction of the large open area around the vehicle buckle provided by the booster seats;

FIG. 6 is a side upper perspective view of the lower base portion and armrest opening covers removed to expose an armrest opening;

FIG. 7 is an upper perspective view of a lower base portion of a booster seat having the armrests removed and armrest opening cover installed;

FIG. 8 is a side upper perspective view of the lower base portion and armrest opening covers of FIG. 7;

FIG. 9 is a front view of a booster seat having all possible seat cover modules installed on the booster seat;

FIG. 10 is an upper perspective view of the booster seat of FIG. 9, with two seat cover modules having been removed therefrom;

FIG. 11 is an enlarged view of a portion of the booster seat of FIG. 9, from which one of the seat cover modules has been removed;

FIG. 11A is identical to FIG. 10, but used to label and highlight certain features of a seatbelt-accommodating slot;

FIG. 11B is identical to FIG. 4, but used to label and highlight an exemplary, optimized position of the seatbelt-accommodating slot;

FIG. 12 is a side view of a seat cover module;

FIG. 13 is a partial rear, upper perspective view of the seat cover module;

FIG. 14 is a partial upper perspective view of the seat cover module installed on the booster seat;

FIG. 15 is a schematic view illustrating a pair of ¼ turn fasteners that may be used to connect a padding module to a booster seat frame;

FIG. 16A is an upper perspective view of a cupholder having an upper snack tray in a first rotational position relative to a lower cup body;

FIG. 16B is an upper perspective view of the cupholder of FIG. 16A, with the upper snack tray in a second rotational position relative to the lower cup body; and

FIG. 17 is an upper perspective view of a second embodiment of a booster seat.

Common reference numerals are used throughout the drawings and the detailed description to indicate the same elements.

### DETAILED DESCRIPTION

The detailed description set forth below in connection with the appended drawings is intended as a description of certain embodiments of a child booster seat and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a vehicle booster seat for a child, with the booster seat being specifically designed to allow for installation of a set of three booster seats in a single row of a vehicle. The booster seats may be specifically configured to include a lower base having a specific contour, such that a cupholder cavity may be collectively defined by two adjacent booster seats. As such, the footprint for the cupholder may not need to be entirely included in the overall footprint of a single lower base portion, which allows for a more compact design. Furthermore, the booster seat may be configured to allow for open an easy access to the vehicle buckles, even when three booster seats are arranged in a single row. The booster seat may also include removeable features, such as a seatback (see FIG. 3) and/or the armrests to enhance the overall flexibility and versatility of the booster seat.

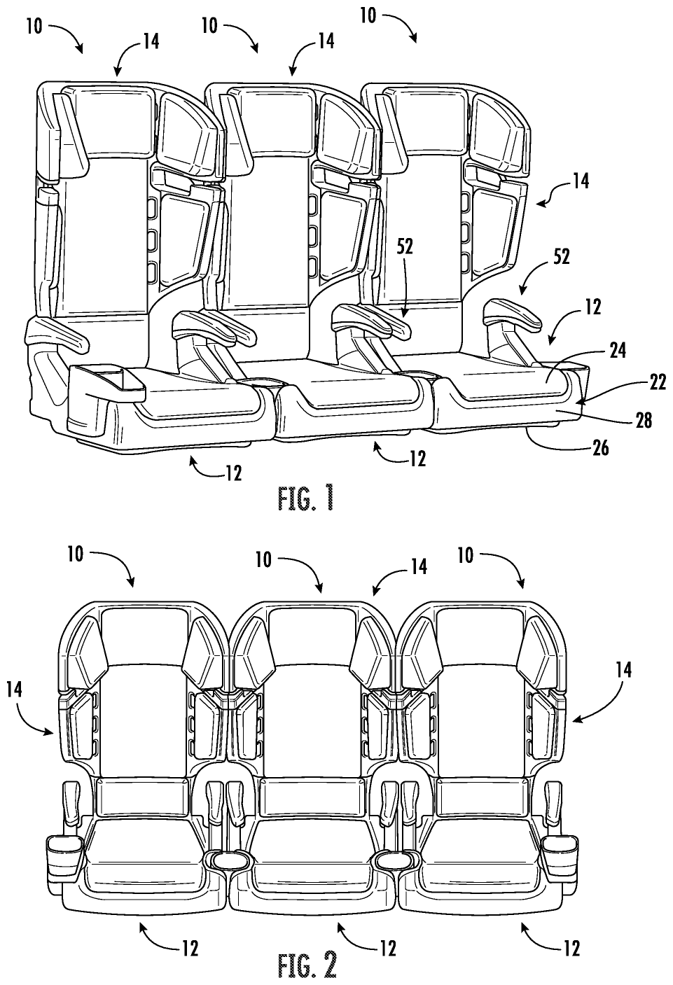

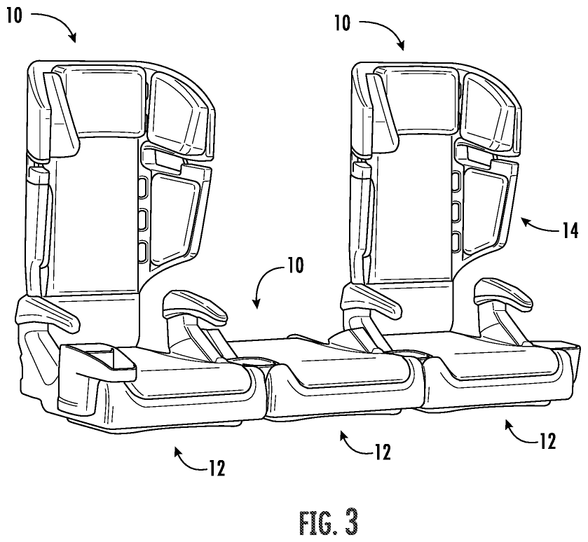

Referring now specifically to FIGS. 1 and 2, a set of three booster seats 10 is depicted in a single-row alignment, e.g., the booster seats 10 being positioned side-by-side-by-side. Each booster seat 10 includes a lower base 12 and an upper seatback 14 detachably engageable with the lower base 12. The lower base 12 may be configured to allow a child to sit directly thereon to serve as the primary support for the weight of the child, while the upper seatback 14 may provide a back support to a child seated on the lower base 12.

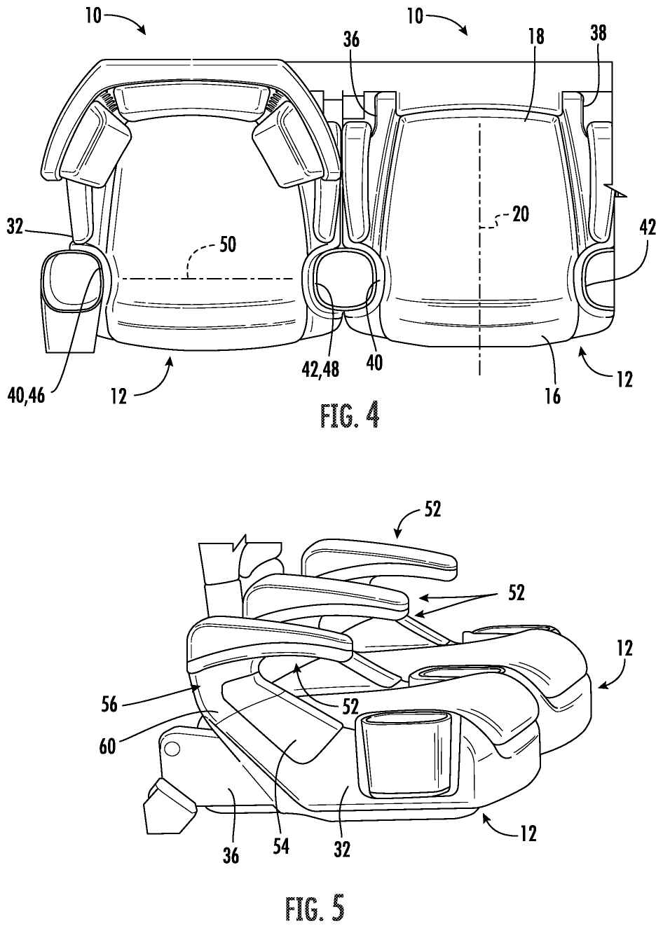

The lower base 12 may include a forward region 16 (see FIG. 4) and a rearward region 18, and may define a first axis 20 (e.g., a central axis) extending in a front-to-back direction (e.g., from the forward region 16 to the rearward region 18). The lower base 12 may include a lower frame 22 and a lower pad 24 detachably connectable to the lower frame 22, as will be described in more detail below. The lower frame 22 may be formed from a plastic, rubber, polymer, or other material known in the art. The lower frame 22 may include a bottom surface 26, a front wall 28, a rear wall 30 (see FIG. 6), a first sidewall 32 (see FIG. 4), and a second sidewall 34 (see FIG. 4), with the first and second sidewalls 32, 34 extending from the front wall 28 in opposed relation to each other. In one embodiment, the first and second sidewalls 32, 34 may each be generally parallel to the first axis 20, although it is contemplated that the first and second sidewalls 32, 34 may have an arcuate configuration or other non-parallel configuration without departing from the spirit and scope of the present disclosure. The lower frame 22 may additionally include a first narrowing wall 36 (see FIG. 4) and a second narrowing wall 38 at a rearward region 18 of the lower frame 22. The first narrowing wall 36 may extend from the first sidewall 32 in both a rearward direction (e.g., toward the rear wall), as well as in a medial direction (e.g., toward the first axis 20). The second narrowing wall 38 may extend from the second sidewall 34 in both a rearward direction as well as in a medial direction opposite to the medial direction of the first narrowing wall 36. In this regard, the narrowing walls 36, 38 may be angled inwardly or medially toward the first axis 20 relative to the sidewalls 32, 34. The effect of both the first and second narrowing walls 36, 38 extending in opposing medial directions is that the rearward region 18 of the lower base 12 may be narrow than the forward region 16, which may create more space around the seat buckles to facilitate insertion of one buckle into another buckle. The creation of more space may be particularly useful when multiple booster seats 10 are placed in a single row and there is less room for lateral movement of the booster seat 10 when trying to buckle the seat belt. In an alternative embodiment, the first and second narrowing walls 36, 38 may be medially offset toward the first axis 20 relative to the first and second sidewalls 32, 24, respectively, to create more space around the buckles. In other words, the first and second narrowing walls 36, 38 may be offset toward the first axis 20 relative to the sidewalls 32, 34.

The lower base 12 may additionally include a pair of recesses 40, 42 from the first and second sidewalls 32, 34, respectively, with each recess 40, 42 being configured to partially define a cavity for use as a cupholder. A first recess 40 may be defined by a first recess wall 46 extending toward the first axis 20 from the first sidewall 32, while a second recess 42 may be defined by a second recess wall 48 extending toward the first axis 20 from the second sidewall 34. The first and second recess walls 46, 48 may come in a variety of shapes, such as arcuate, semi-circular (e.g., 180 degrees or less), or multi-sided with corners, where the corners may be rounded or square. The first and second recesses 40, 42 may be aligned with each other such that a cupholder axis 50 passes through both the first and second recesses 40, 42. In this regard, the first and second recess walls 46, 48 may be spaced from the front wall 28 by a common distance. During use, the first recess 40 may cooperate with a second recess 42 on an adjacent lower base 12 to define the cupholder, and the second recess 42 may cooperate with a first recess 40 on a separate adjacent lower base 12 to define another cupholder. The cupholder(s) may be sized to receive a cup, bottle, thermos or other drinking container for ease of access for a child seated in the booster seat 10. The cupholder may also be sized to receive a cupholder liner/insert, which in turn may receive a cup, bottle, thermos, or the like.

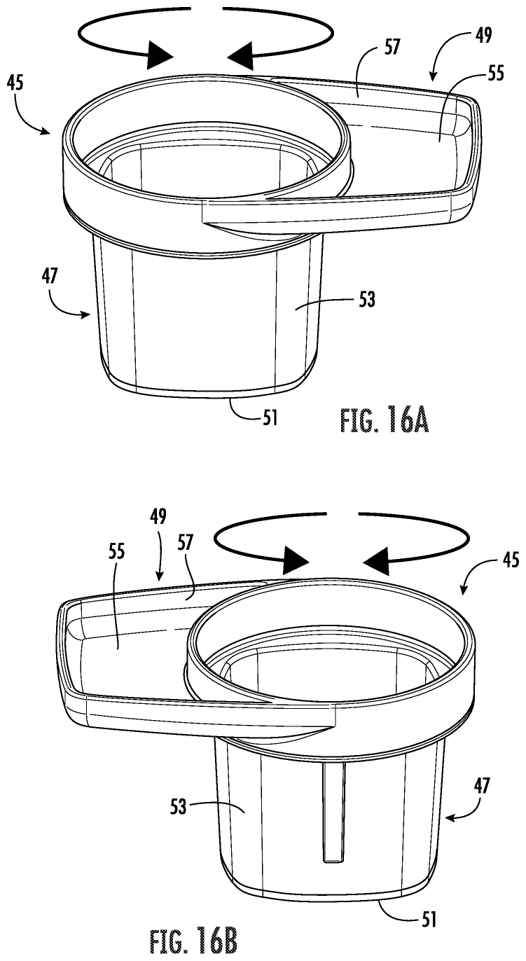

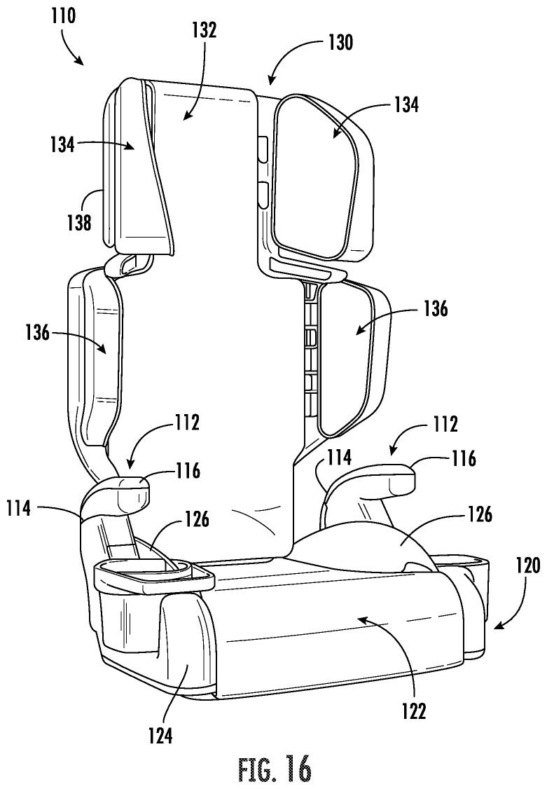

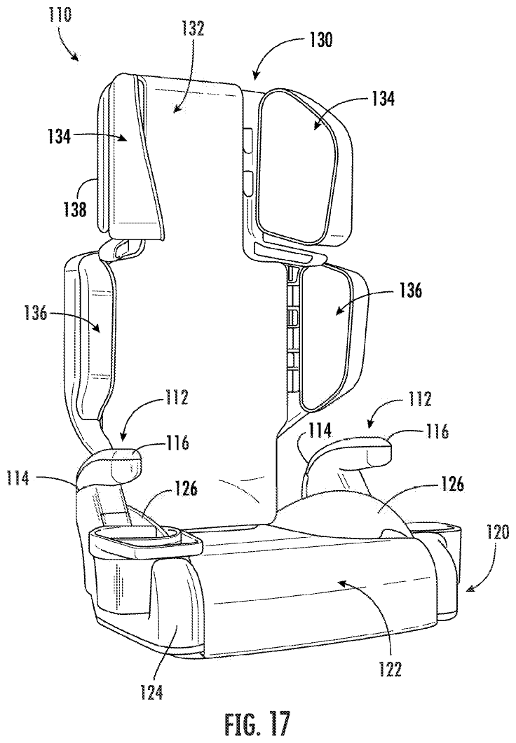

Referring now to FIGS. 16A and 16B, one embodiment of a cupholder insert 45 is shown and includes a lower body 47 and an upper tray 49. The lower body 47 is configured to be received within the cupholder defined by the first and second recesses 40, 42. The lower body 47 may include a lower wall 51 and a sidewall 53 extending upwardly from the lower wall 51. The upper tray 49 may include an upper plate 55 extending radially outward from the sidewall 53 of the lower body 47, with the upper tray 49 additionally including an upper sidewall 57 extending around the upper plate 55. The upper plate 55 may be sized to allow for snacks or small toys to be placed thereon for easy access to a child sitting in an adjacent seat. The upper sidewall 57 may be configured to help in retaining the snacks or toys on the upper plate 55.

The upper tray 49 may be connected to the sidewall 53 and may be rotatable relative to the sidewall 53. The lower body 47 may define a height between the lower wall 51 and the upper tray 49 to allow the upper tray 49 to be located outside of the cupholder so as to allow the upper tray 49 to rotate relative to the lower wall 51 without being obstructed by the sidewall 32, 34 of the lower base 12. In one embodiment, the upper tray 49 is rotatable 180 degrees relative to the lower body 47, while in other embodiments, the upper tray 49 is rotatably by 360 degrees relative to the lower body 47. The rotation of the upper tray 49 relative to the lower body 47 allows the upper tray 49 to extend toward the front of a specific booster seat 10 or a desired position of use. Thus, if the cupholder insert 45 is positioned on the right side or left side of the seat 10, or between two booster seats 10, the upper tray 49 may be rotated toward the front of the booster seat 10 or desired position of use (e.g., the seat 10 supporting the child using the upper tray 49). The rotatable interconnection between the upper tray 49 and the lower body 47 may be by any technique known in the art that allows for rotation of the upper tray 49 relative to the lower body 47. For instance, one of the upper tray 49 and lower body 47 may include a groove which receives a projection on the other one of the upper tray 49 and lower body 47, with the projection being moveable within the groove. It is also contemplated that bearings may also be used to facilitate rotation of the upper tray 49 relative to the lower body 47. The upper tray 49 and lower body 47 may also be configured to allow the upper tray 49 to remain in the desired position until a sufficient force is applied to the upper tray 49 to cause the upper tray 49 to rotate relative to the lower body 47. In this regard, the upper tray 49 may be configured to remain in the desired position while the vehicle is being driven. As such, routine turning of the vehicle, or passing over bumps, may not cause the upper tray 49 to move relative to the lower body 47.

Although it is contemplated that adjacent lower bases 12 may be configured to collectively define a cupholder via their respective first and second recess walls 46, 48, it is also contemplated that in the event one of the first and second recess walls 46, 48 is not facing an adjacent lower base 12, the first and second recess walls 46, 48 may be configured to define a space which may accommodate a cup, bottle, thermos, or the like by itself. In this regard, when three booster seats 10 are positioned in a single row, the middle booster seat 10 will define a pair of cupholders with the outermost booster seats 10, while the outermost booster seats 10 will also each independently define a respective outside-most cupholder. In this regard, the first and second recess walls 46, 48 may define a rib, lip, or projection relative to the adjacent surface of the lower base 12 which may be used to grab or engage with a cup or a cupholder liner.

With reference to FIG. 5, each lower base 12 may also include a pair of armrests 52 for providing support to the hands and arms of a child seated on the booster seat 10. Each armrest 52 may include a permanent base portion 54, and a removable arm support portion 56. Each permanent base portion 54 may extend from the lower frame 22, and in particular, from a rearward region of one of the first and second sidewalls 32, 34 in a rearward and upward direction. In this regard, when the booster seat 10 is placed on a vehicle seat, the permanent base portion 54 may extend above the vehicle seat, which further aids in creating space around the buckles. In this regard, permanent base portion 54 attaches to the sidewalls 32, 34 at a forward portion of the lower frame 22, rather than attaching to the directly underlying region of the lower frame 22 (e.g., the first and second narrowing walls 36, 38).

The removable arm support portion 56 may include an arm 58, an exposed extension body 60, and a connecting body (not shown). The arm 58 is configured to extend generally horizontally when the removeable arm support portion 56 is connected to the permanent base portion 54 so as to provide support to a child's hands or forearms when the child is seated in the booster seat 10. In this regard, the term “generally horizontally” is used broadly to refer to any position of the arm 58 that may provide the previously-described support to the child. As such, the arm 58 may extend slightly upwardly or downwardly, or may have a curved or arcuate surface, while extending generally horizontally. The arm 58 may have a rearward end portion and a forward end portion, with the rearward end portion being connected to the exposed extension body 60 and the forward end portion extending forwardly from the exposed extension body 60. The arm 58 may be configured such that the forward end portion terminates before extending directly over the cupholder to allow for easy insertion and removal of cups, etc., into and out of the cupholder.

The connecting body (not shown) may extend from the exposed extension body and may be configured to detachably engage with the permanent base portion 54. In this regard, as seen in FIG. 6, the permanent base portion 54 may include a cavity or recess 62, and the connecting body may include a shaft or other protruding body configured to be received in the recess 62 and frictionally engage with the permanent base portion 54 to facilitate detachable engagement therebetween. The frictional engagement may be strong enough to prevent a young child from pulling the removable arm support portion 56 from the permanent base portion 54, yet weak enough to allow an adult to pull the removable arm support portion 56 out of the permanent base portion 54.

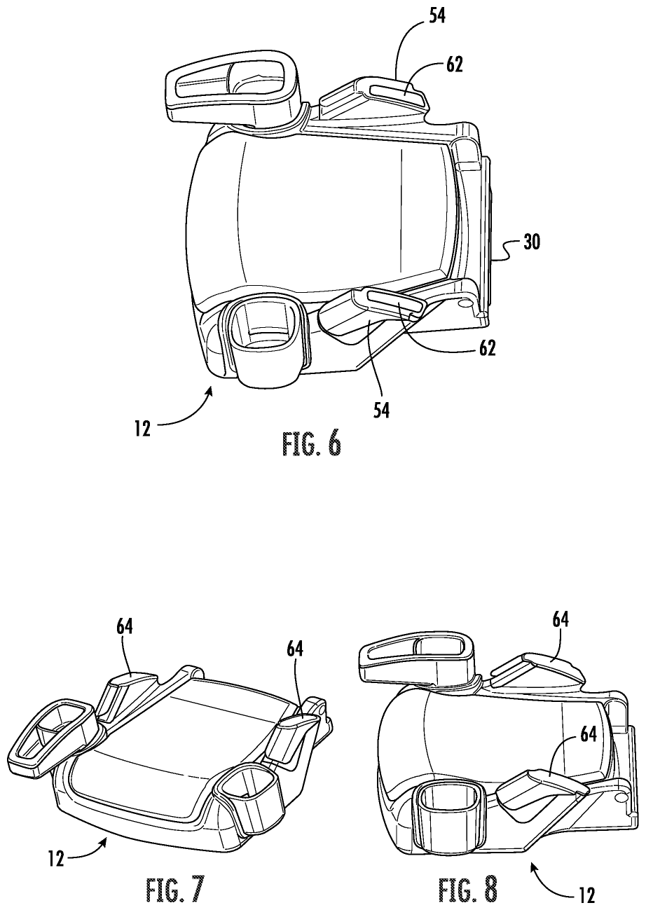

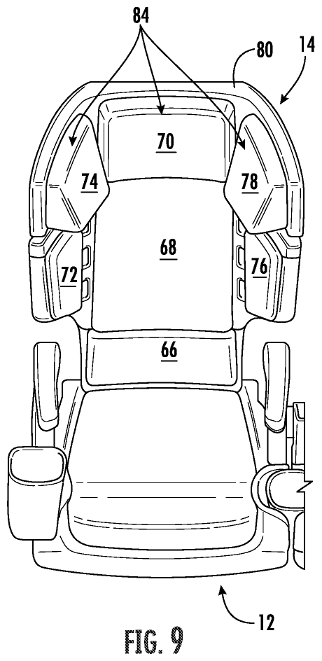

As seen in FIGS. 7 and 8, when the removable arm support portion 56 is removed from the permanent base portion 54, the cavity in the permanent base portion 54 may be exposed or open. Therefore, the booster seat 10 may include a pair of covers 64 that are selectively engageable with respective permanent base portions 54 to cover the cavity 62 when the removable arm support portions 56 are removed therefrom.

The lower base 12 is configured to be detachably engageable with the seatback 14 to allow for selective variation in the configuration of the booster seat 10 to accommodate the specific needs of the child seated therein. In this regard, the seatback 14 may include a lower support region 66, a middle support region 68, an upper support region 70, a first side lower support region 72, a first side upper support region 74, a second side lower support region 76 and a second side upper support region 78. The first and second side regions 72, 74, 76, 78 may extend from opposite sides of the middle and upper support regions 68, 70 in an outward direction and a forward direction to provide lateral support to a child seated in the booster seat 10. The seatback 14 may include a rigid, unitary seatback frame 80 that may extend over all of the aforementioned regions. The seatback 14 may additionally include a plurality of pads, with each region including one or more pads or padding modules (discussed in more detail below) coupled to a seatback frame 80 and configured to interface with the child seated in the booster seat 10 to enhance the comfort for the child. The seatback 14 may include a space or slot 82 between the first side lower and upper support regions 72, 74 as well as between the second side lower and upper support regions 76, 78. The space or slot 82 may be configured to facilitate passage of an over-the-shoulder seatbelt therethrough.

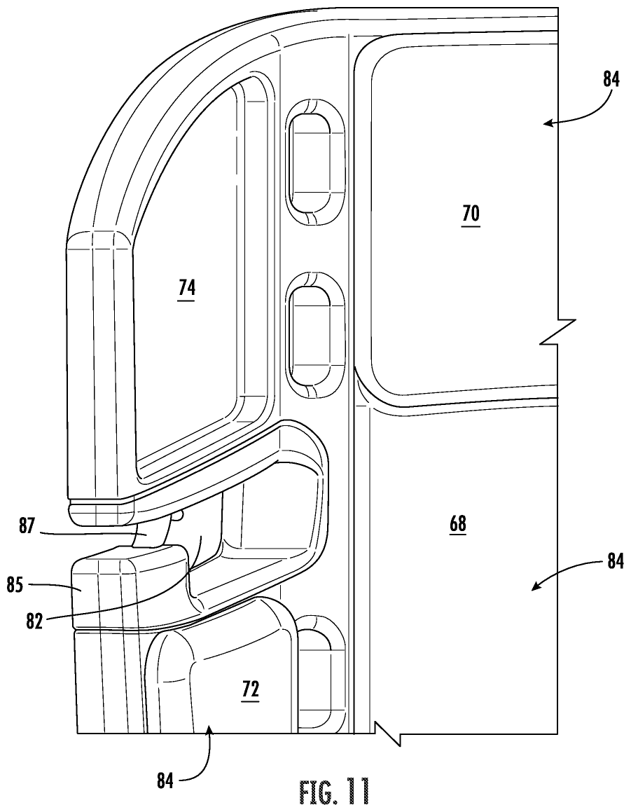

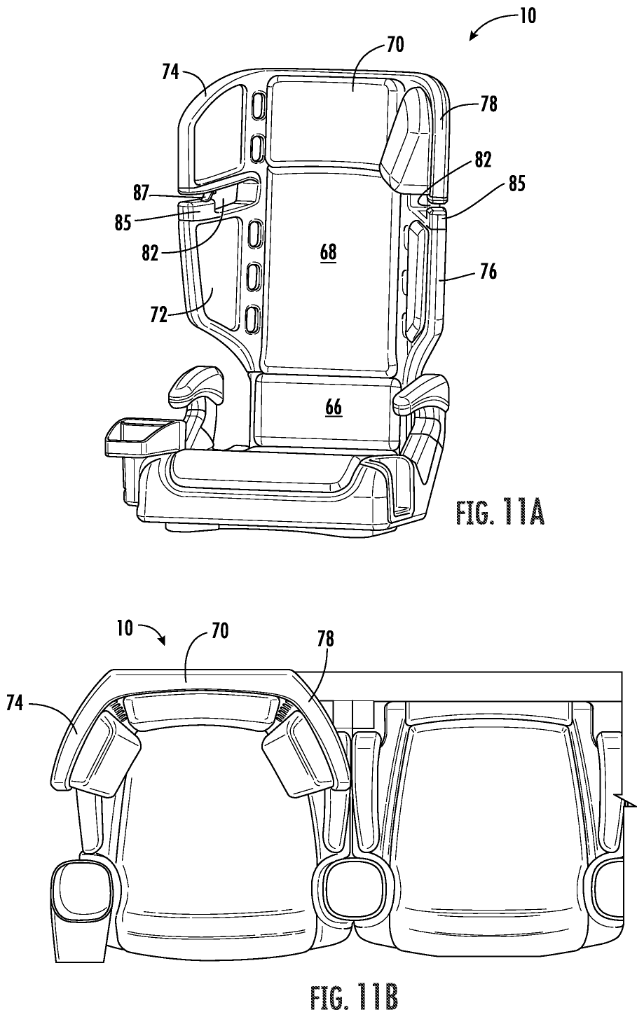

In greater detail, and with particular reference to FIGS. 11, 11A and 11B, according to one embodiment, the forwardly extending orientation of the first and second side regions 72, 74, 76, 78 relative to the lower support region 66, middle support region 68, and upper support region 70 may allow for positioning of the seatbelt-accommodating slot 82 in a desirable location relative to a child seated within the booster seat 10. In this regard, the slot 82 may be positioned forward of the lower support region 66, middle support region 68, and upper support region 70, which may route the over-the-shoulder portion of the seatbelt from where it is stowed on the vehicle to a more suitable position for the size of the child. This positioning of the seatbelt may also allow an adult caretaker, or older child, to more easily interface with the over-the-shoulder portion of the seatbelt.

Further, the slot 82 may be formed in a slot body 85 that connects to at least one of the corresponding upper and lower side bodies 74, 78, 72, 76. Alternatively, the slot body 85 may be integrally formed with the upper and lower side bodies 74, 78, 72, 76, or may be defined by the upper and lower side bodies 74, 78, 72, 76. A spring biased retaining body 87 may be coupled to the slot body 85 and may be transitional between a closed position and an open position. In the closed position, the retaining body 87 extends across an entryway/passage extending from an outer edge of the booster seat to the slot. In the open position, the retaining body is moved such that the entryway/passage is at least partially cleared to allow for passage of the seatbelt therethrough. The retaining body 87 may be sized and configured to allow for easy insertion of the seatbelt into the slot 82, while inhibiting inadvertent removal of the seatbelt from the slot 82. In this regard, the retaining body 87 may be angled toward to the slot 82, such that advancement of the seatbelt into the slot 82 may cause the retaining body 87 to transition from the closed position to the open position. Thus, a user may be required to manually transition the retaining body 87 from the closed position to the open position to allow for removal of the seatbelt from the slot 82.

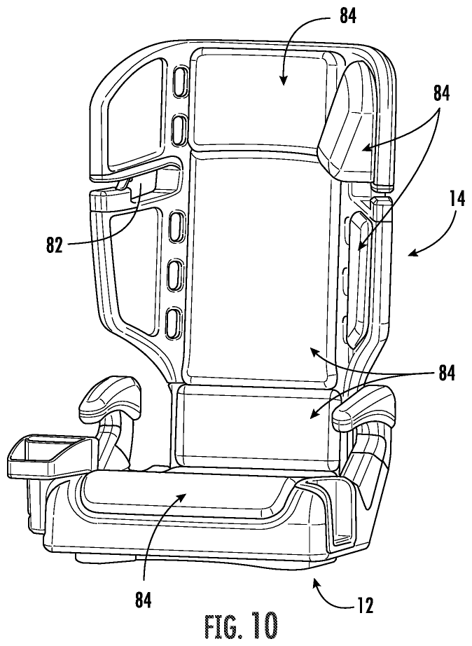

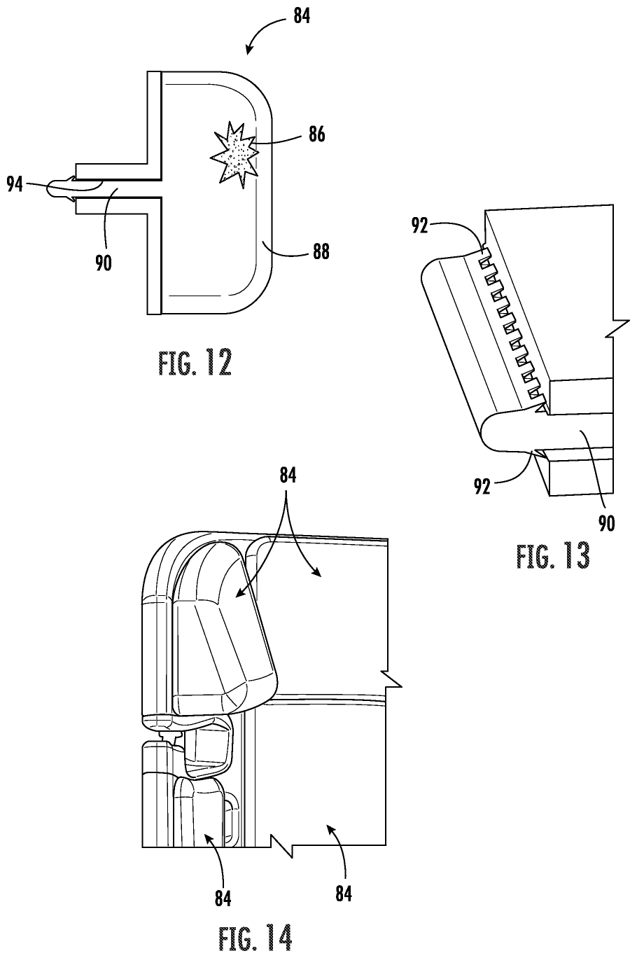

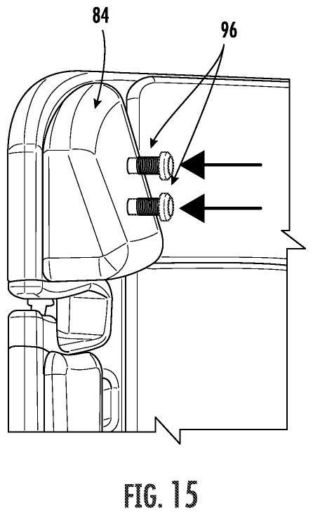

Referring now to FIGS. 9-14, various embodiments of the booster seat 10 may include removeable padding modules 84 that may be connected to the lower frame 22 or the seatback frame. Each module 84 may include a pad 86 (see FIG. 12) and a cover 88, with the cover 88 being formed of a fabric having a particular color, pattern or design. The ability to remove the padding modules 84 allows for ease in cleaning the cover 88 should the cover 88 become dirty. Alternatively, the user may connect certain modules 84 that are different colors to achieve a desired color scheme. FIG. 9 shows a booster seat 10 with padding modules 84 coupled to all corresponding regions of the booster seat 10, while FIG. 10 shows padding modules 84 having been removed from the first side lower and upper support regions 72, 74 and FIG. 11 shows a padding module 84 as having been removed from the first side upper support region 74.

FIG. 12 is a partial cross sectional view showing attachment of a padding module 84 to a portion of the booster seat frame, which may be the lower frame 22 or the seatback frame 80. The padding module 84 includes an internal pad 86, a cover 88, a connecting fin 90, and one or more locking flanges 92 extending from the connecting fin 90. The connecting fin 90 may extend away from the internal pad 86 and may be configured to extend through a slot or opening formed in the booster seat frame. The padding module 84 may include a plate, to which the internal pad 86 may be mounted, and from which the connecting fin 90 may extend. The connecting fin 90 may be configured as a plate, pin, post, or other structure.

The locking flanges 92 may include resilient flanges that may extend from the connecting fin 90 in a prescribed angular direction which allows for easy insertion of the connecting fin 90 into a slot 94 formed in the booster seat frame, yet restricts removal of the connecting fin 90 from the slot 94. In particular, each locking flange 92 may extend from the connecting fin 90 away from the connecting fin 90 and toward the internal pad 86. Each locking flange 92 may be flexible between a natural position and a flexed position, with a distal end of the locking flange 92 moving toward the connecting fin 90 as the locking flange 92 moves from the natural position towards the flexed position. In this regard, when the connecting fin 90 is inserted through the slot 94, the walls of the frame forming the slot 94 may press against the locking flange 92 to urge the locking flange 92 from its natural position, toward the connecting pin to assume its flexed position to allow for insertion of the connecting pin 90 through the slot 94. When the entirety of locking flange 92 has passed through the slot 94, the locking flange 92 may be free to transition from the flexed position toward its natural position, due to the natural resiliency of the locking flange 92.

Once the connecting pin 90 has been inserted and the locking flange 92 has assumed its natural position, the locking flange 92 may engage or contact with an internal surface of the frame to restrict inadvertent removal of the module 84 from the frame. In this regard, if a child were to pull on the module 84, it is likely that the force needed to flex the locking flange 92 from the natural position toward the flexed position would be too great for a child to pull the module 84 out of engagement with the frame. However, an adult may be capable of pulling the module 84 with a larger, more intentional, force to overcome the internal resiliency of the locking flange 92 and cause the locking flange 92 to transition from the natural position toward the flexed position to allow for removal of the connecting pin through the slot 94.

The transition of the locking flange 92 from the natural position toward the flexed position may occur in many directions. For instance, when the locking flange 92 transitions from the natural position toward the flexed position during insertion of the connecting pin 90 within the slot 94, the locking flange 92 may simply be pressed toward the connecting pin 90. However, when the locking flange 92 transitions from the natural position toward the flexed position during removal of the connecting pin 90 from the slot 94, the locking flange 92 may be folded over itself, with a distal/free end of the locking flange 92 being moved toward a distal/free end of the connecting pin 90.

It is contemplated that other attachment mechanisms and techniques known in the art may also be employed to connect the padding module 84 to the booster seat frame. For instance, FIG. 15 shows a pair of ¼-turn fasteners 96 that may be used to secure the padding module 84 to the booster seat frame. Although the arrows show the fasteners 96 as being insertable in a right-to-left direction from the perspective depicted in FIG. 15, it is contemplated that the fasteners 96 may be inserted in the opposite direction, i.e., from the back of the booster seat frame. In this regard, the booster seat frame may include a plurality of openings sized to allow for passage of the shaft portions of the fasteners 96 therethrough to engage with internally threaded openings formed on the padding module 84. Thus, the padding module 84 may be easily connected to the booster seat frame by inserting the fasteners 96 and rotating the fasteners 96 in a first rotational direction by approximately 90 degrees. To disconnect the padding module 84, the fasteners 96 may be rotated in a second rotational direction, opposite to the first rotational direction, by approximately 90 degrees to facilitate removal of the fasteners from the openings formed in the padding module 84.

Referring now to FIG. 17, there is depicted another embodiment of a booster seat 110, with the primary distinctions being the configuration of the armrests 112 and the padding. In this regard, the following discussion will be limited to the unique features of the booster seat 110 depicted in FIG. 17. All other features of the booster seat 110 may be similar to the booster seat 10 described above.

The booster seat 110 of FIG. 17 includes a pair of armrests 112 that are configured to provide even easier access to the seatbelt connector. In this regard, each armrest 112 may be slanted, curved, or angled downwardly toward a rear end portion 114 thereof. In this respect, a forward end portion 116 of the armrest 112 may be positioned above the rear end portion 114 of the armrest 112. This configuration of the armrest 112 may provide more space around the seatbelt connector to allow the user to more easily connect the seatbelt and release the seatbelt.

The booster seat 110 of FIG. 17 includes a lower base 120 having a primary padding module 122 extending over the top and front of the lower base frame 124, as well as a pair of hip pads 126 extending on opposite sides of the primary pad 122. The primary padding module 122 may include a single unitary pad and may include a pocket on the reverse to facilitate the installation of additional comfort padding materials. The hip pads 126 may extend upwardly from the lower base frame 124 and may be configured to cradle or provide gentle lateral support to the child seated on the lower base 120. In this regard, the hip pads 126 may be slightly flexible or deformable in response to the child sitting down on the seat against the hip pads 126 or leaning against the hip pads 126.

The upper seatback 130 may include a central padding module 132, a pair of upper head padding modules 134 and a pair of side support padding modules 136. Each padding module 132, 134, 136 may be comprised of a single pad element or multiple pad elements. Furthermore, each padding module 132, 134, 136 may include a cover that extends over an internal pad, such that the cover extends around the exposed portion of the pad protruding from seatback frame 138. The covers may be detachable to allow for cleaning of the pad module 132, 134, 136 or swapping of the pad module 132, 134, 136 to achieve a desired aesthetic look (e.g., swapping a pad module 132, 134, 136 that is a first color with a pad module 132, 134, 136 that is a second color). In the case of a detachable cover, the cover may include an elasticized peripheral edge, similar to a fitted sheet for a bed, to allow the detachable cover to extend over and around the pad element for donning and removal of the cover from the pad element. However, when the cover is disposed on the pad element, the elasticized edge may constrict to prevent inadvertent removal of the cover from the pad element.

The pad elements or padding features included in the booster seats 10, 110 described herein may be formed from foam, rubber, or other materials known in the art.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A booster seat for supporting a child in a vehicle, the booster seat comprising:
a lower base having a pair of sidewalls extending on opposing sides of a central axis, and a pair of narrowing walls also extending on opposing sides of the central axis, each of the pair of narrowing walls including at least one segment that is positioned between a pair of planes defined by the pair of sidewalls;
a seatback frame connectable to the lower base and having a plurality of slots formed therein; and
a plurality of padding modules detachably engageable with the seatback frame, each padding module including a pad, a connecting fin coupled to the pad, and a locking flange coupled to the connecting pin, each of the plurality of padding modules being insertable into a respective one of the plurality of slots to facilitate engagement between the plurality of padding modules and the seatback frame, each locking flange engaging the seatback frame when the corresponding padding module is inserted in the slot.

2. The booster seat recited in claim 1, wherein the seatback is detachably connectable to the lower base.

3. The booster seat recited in claim 1, wherein the pair of sidewalls defining a maximum width therebetween and the pair of narrowing walls defining a minimum width therebetween, the minimum width being less than the maximum width.

4. The booster seat recited in claim 1, further comprising at least one recess formed in the lower base, the at least one recess extending into the lower base from a respective one of the pair of sidewalls.

5. The booster seat recited in claim 4, further comprising a cupholder insert configured to be removably received within a respective one of the at least one recess.

6. The booster seat recited in claim 5, wherein the cupholder insert includes a lower body defining a cup-holding recess and an upper portion defining a plate extending radially outward from the cup-holding recess.

7. The booster seat recited in claim 6, wherein the plate is selectively rotatable relative to the lower body.

8. The booster seat recited in claim 4, wherein the at least one recess defines an arclength less than or equal to 180 degrees.

9. The booster seat recited in claim 4, wherein the at least one recess includes a pair of recesses positioned in opposed relation to each other.

10. The booster seat recited in claim 1, wherein the lower base further includes a pair of armrests in opposed relation to each other.

11. The booster seat recited in claim 10, wherein each armrest includes a base portion and a removable arm portion, the base portion being coupled to a respective one of the pair of sidewalls and the removable arm portion being configured to be detachably engaged with the base portion.

12. The booster seat recited in claim 1, wherein the lower base includes an upper padding module extending between the pair of sidewalls, and a pair of hip pads extending from opposed side portions of the upper padding module.

13. A booster seat for supporting a child in a vehicle, the booster seat comprising:
a lower base having a pair of sidewalls extending on opposing sides of a central axis, and a pair of narrowing walls also extending on opposing sides of the central axis, each of the pair of narrowing walls including at least one segment that is positioned between a pair of planes defined by the pair of sidewalls;
a seatback frame connectable to the lower base; and
a plurality of padding modules operatively coupled to the seatback frame, each padding module including a pad and a respective cover, at least one of the pad or the cover configured to be removable from the seatback frame

14. The booster seat recited in claim 13, wherein each pad is detachably engageable with the seatback frame and each cover is fixedly connected to a respective pad.

15. The booster seat recited in claim 13, wherein each pad is fixedly coupled to the seatback frame and each cover is removable from the corresponding pad.

16. The booster seat recited in claim 13, further comprising at least one recess formed in the lower base, the at least one recess extending into the lower base from a respective one of the pair of sidewalls.

17. The booster seat recited in claim 16, further comprising a cupholder insert configured to be removably received within a respective one of the at least one recess.

18. The booster seat recited in claim 17, wherein the cupholder includes a lower body defining a cup-holding recess and an upper portion defining a plate extending radially outward from the cup-holding recess.

19. The booster seat recited in claim 18, wherein the plate is selectively rotatable relative to the lower body.

20. A primary booster seat for supporting a child in a vehicle, the primary booster seat being configured for use with a cupholder and an adjacent booster seat having a lateral recess formed therein, the primary booster seat comprising:
a lower base having:
a pair of sidewalls extending on opposing sides of a central axis;
a pair of narrowing walls also extending on opposing sides of the central axis, each of the pair of narrowing walls including at least one segment that is positioned between a pair of planes defined by the pair of sidewalls; and
a primary recess extending from one of the pair of sidewalls, the primary recess being configured such that when the primary booster seat is positioned adjacent the adjacent booster seat, the primary recess and the lateral recess cooperatively define a cupholder recess sized to receive the cupholder;
a seatback frame connectable to the lower base and having a plurality of slots formed therein; and
a plurality of padding modules detachably engageable with the seatback frame, each padding module including a pad, a connecting feature coupled to the pad, and a locking flange coupled to the connecting feature, each of the plurality of padding modules being insertable into a respective one of the plurality of slots to facilitate engagement between the plurality of padding modules and the seatback frame, each locking flange engaging the seatback frame when the corresponding padding module is inserted in the slot.
